(19) United States
(12) Patent Application Publication
(10) Pub. No.: US 2008/0210172 A1
(43) Pub. Date: Sep. 4, 2008

(54) Squirrell-proof bird feeder

(76) Inventor: Jack P. Waikas, Louisburg, NC (US)

Correspondence Address: CAHN & SAMUELS LLP, 1100 17th STREET NW, SUITE 401, WASHINGTON, DC, 20036, US

(21) Appl. No.: 11/868,115

(22) Filed: Oct. 5, 2007

Related U.S. Application Data
(60) Provisional application No. 60/849,789, filed on Oct. 6, 2006.

(51) Int. Cl. A01K 39/014

(52) U.S. Cl. 119/52.3; 119/51.01; 119/52.1; 119/52.2

(57) ABSTRACT

An anti-squirrel bird feeder comprising a feed cylinder and an anti-squirrel carousel. The carousel is spring biased in an open position wherein feed opening in the feed cylinder may be accessed by birds resting on perches disposed on the carousel. Upon receiving a weight above a predetermined amount, the spring bias is overcome resulting in the carousel sliding down the cylinder until a shut-off flanges blocks access to the feed openings. The spring force at which the feeder will close may be made adjustable and the feed openings may empty into a trough having weep holes for removing water from the feed.

### I. CROSS-REFERENCE TO RELATED APPLICATIONS

This application claims the benefit of U.S. Provisional Patent Application No. 60/849,789, filed Oct. 6, 2006, which is incorporated herein by reference.

### II. FIELD OF THE INVENTION

The present invention relates to bird feeders. More particularly, the present invention relates to improved bird feeders for providing a readily available source of clean, dry feed for birds, wherein the feeders also include squirrel resistant features to prevent other animals from accessing the feed.

### III. BACKGROUND OF THE INVENTION

One of the few areas of wildlife study that lends itself to the backyard is ornithology, or the study of birds. Bird enthusiasts across the globe have long understood that providing a steady source of food and/or fresh water are certain ways to attract native bird species to their yards. Numerous artisans have strived to build bird feeders that improve the ability of amateur bird enthusiast to successfully lure bird species to their yards.

Most of today's bird feeders share the same core design, wherein a vertically oriented tube is filled with seed that is accessible in small troughs gravitationally filled via feed openings carved into the bottom of the tube's sidewall. The tube typically includes a wire rung or like structure disposed around the circumference of the tube bottom in a manner that allows birds to perch and access seeds. As will be appreciated, these tube-type feeders suffer from a number of drawbacks. For example, providing a food source inevitably attracts other wildlife, such as squirrels, that are interested in gaining access to the seeds. With a tube-type bird feeder that hangs from a tree branch, a squirrel simply crawls down the branch and helps himself to the seed via the feed openings. Moreover, even when the openings may include fencing sized to prevent a squirrels' head from reaching the feed openings, the cunningness of squirrels eventually leads to their discovery that shaking the feeder or its supporting branch results in seed spewing from the feed openings onto the ground where it can be foraged. In addition to the nuisance of rodents emptying the contents of the feeders by climbing or shaking, many of these prior art feeders suffer from the additional drawback of the seed getting wet from exposure to rain, which may result in clogging of the feed openings, or worse, harmful mold and bacterial growth that may make the seed unsafe for consumption by birds. In a similar vein, these prior art devices fail to account for the need to periodically cleanse and sanitize the feeder. A bird feeder that does not lend itself to easy cleaning is a feeder that does not get cleaned.

Additional drawbacks less readily appreciated include the inability of prior art feeders to discriminate amongst birds to ensure that feed is available for specific birds. Ornithologist will readily agree that homeowners are loath to have their feeders be the destination spot for pigeons or crows. Beyond seed type and perch placement, little has been done in the art to ensure that nuisance birds are kept from the feed while other bird types are provided a regular food source.

The foregoing underscores some of the problems associated with prior art bird feeders. Furthermore, the foregoing underscores the long-felt, yet unresolved need in the art for squirrel-proof bird feeders that provide readily accessible clean, dry feed for birds, or a particular size of bird.

### IV. SUMMARY OF THE INVENTION

Various embodiments of the present invention overcome the practical problems described above and offer new advantages as well. One object of at least one embodiment of the invention is to provide a bird feeder that hinders loss of seed to rodents. Another object of at least one embodiment of the invention is the provision of a bird feeder that hinders the adverse effects of rain. Another object of a least one embodiment of the invention is to provide a bird feeder that is lends itself to ready cleansing and sanitizing. Yet another object of at least one embodiment of the invention is the provision of a bird feeder that allows a user to predetermine the weight of a bird or birds that can access the feed.

According to one advantageous feature of various embodiments of the invention is the ability to completely stop access to seeds when the weight of a squirrel is applied to the feeder. In a preferred embodiment, a carousel comprising the bird rung and tray roof are cooperatively arranged, whereby the weight of a squirrel on the roof or rung causes the carousel to descend in a manner that slides a flange over the feed troughs and/or feed openings.

According to another related feature of various embodiments of the invention is the ability to predetermine the weight at which access to the feed will be shut off. In accordance with this feature of the invention, the weight is determined via spring bias that must be overcome. In one embodiment, a spring is disposed in the base of the feeder and operatively arranged to bias the carousel in an open position, whereby weight sufficient to overcome the spring bias causes the carousel to descend, thereby closing the feed openings. In a preferred embodiment, the spring may be adjusted to determine the weight that will be suitable for shutting off the feed. In another embodiment, the carousel arrangement includes bearings to ensure that binding will not serve to prevent shutting of the feed when the predetermined weight is exceeded. In another preferred embodiment, the spring adjustment mechanism may include a gauge with predetermined settings that may be used to set a given spring bias amount. Preferably, the gauge settings correlate to specific bird settings for ease of use.

According to another advantageous feature of various embodiments of the invention is the ability to suspend the feeder in the air via its top or bottom. In a preferred embodiment, the feeder includes a top having a means for hanging the feeder and a bottom that includes a means for securing the feeder atop a post. According to this feature of the invention, in at least one preferred configuration, top hanging allows for the center of gravity to be such that hard rains and wind will not result in soaking of the feed due to the shape and coverage of the roof.

According to another advantageous feature of various embodiments of the invention is the ability to hinder spillage of seed from the feeder. In accordance with this feature of the invention, a feed trough configured to hinder spills may be provided. In one embodiment, the trough is deep enough and/or disposed in a manner relative the feed openings such that shaking the feeder causes feed to be captured in the trough as opposed to spilling on the ground.

According to another advantageous feature of various embodiments of the invention is ability to keep the feed dry. In accordance with this feature of the invention, the feeder may be provided with a gutter system. In one embodiment, a trough having weep holes for draining water is provided. Preferably, the weep holes are provided in a manner that prevents seeds from clogging them. In addition, as previously mentioned, the feeder may be hung from its top with a roof system configured such that hard rains and wind will not result in soaking of the feed due to the shape of the feeder and coverage of the roof.

According to another advantageous feature of various embodiments of the present invention is the ability to disassemble the feeder for sanitizing to help prevent disease to birds caused by mold or bacteria. In accordance with this feature of the invention, various embodiments of the invention contemplate use of a feed tray or trough that snaps into place around the feed tube. In one embodiment, the feed tray comprises a two-piece collar that snaps together to encircle the feed tube. Also in accordance with this feature of the invention, various embodiments contemplate constructing the feeder out of dishwasher safe material. In a preferred embodiment, the material of construction is polycarbonate. According to a related feature of various embodiments of the invention, the feeder comprises a material that protects the feed from ultraviolet and infrared radiation.

According to another advantageous feature of various embodiments of the invention is the provision of a large supply of feed. In accordance with this aspect of the invention, the hollow tubular trunk of the feeder may comprise a top portion and a bottom portion, wherein the top portion is larger than the bottom portion. In one embodiment, the feeder includes an aesthetically proportioned feed tube having a much larger top volume for holding seeds than a typical linear tube feeder. Preferably, the feeder includes a first roof disposed above the top portion and a second roof disposed above the second portion. More preferably, the roofs include matching shingles or coloration.

According to another advantageous feature of various embodiments of the invention is the provision of an outside thermometer on the top of the feeder. In a preferred embodiment the thermometer is disposed on the filler top.

These and other objects and advantages of the present invention may be realized by one or more of the embodiments described herein. Given the following enabling description of the drawings, the novel bird feeders of the present invention and their various respective advantageous features should become evident to a person of ordinary skill in the art.

### V. BRIEF DESCRIPTION OF THE DRAWINGS

The present invention is described with reference to the accompanying drawings. In the drawings, like reference numbers indicate identical or functionally similar elements.

FIG. 1 illustrates a side view of a preferred embodiment of a bird feeder according to the invention.

FIG. 2 is a perspective view of the bird feeder of FIG. 1

FIG. 3 is an elevated perspective view of the bird feeder of FIG. 1.

FIG. 4 is an enlarge perspective view of the bird feeder of FIG. 1.

FIG. 5 is a bottom perspective view of the bird feeder of FIG. 1.

FIG. 6 is partial-cross sectional view of an embodiment of a bird feeder according to the invention.

FIG. 7 is a bottom view of the bird feeder of FIG. 1.

### VI. DETAILED DESCRIPTION OF THE DRAWINGS

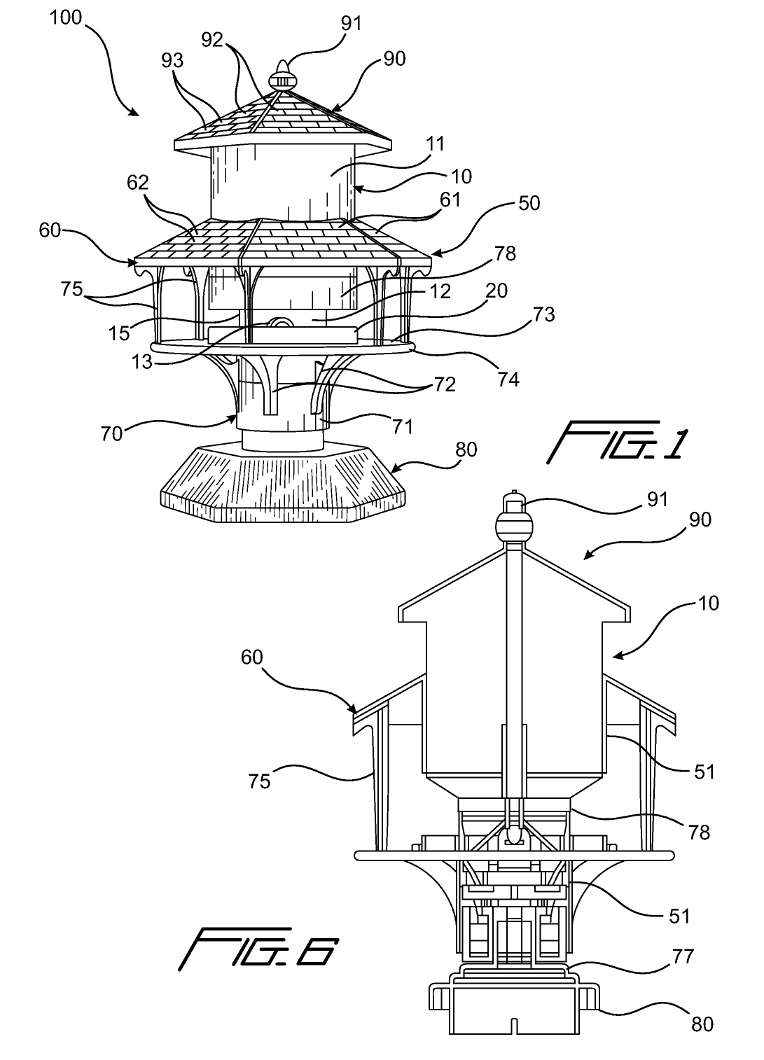

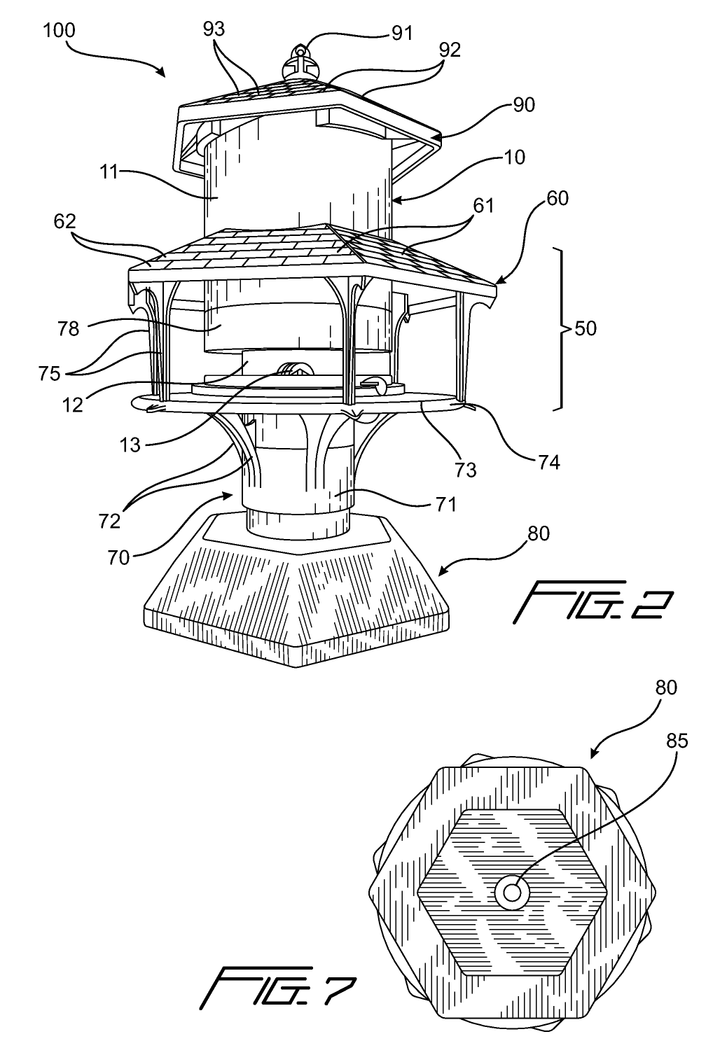

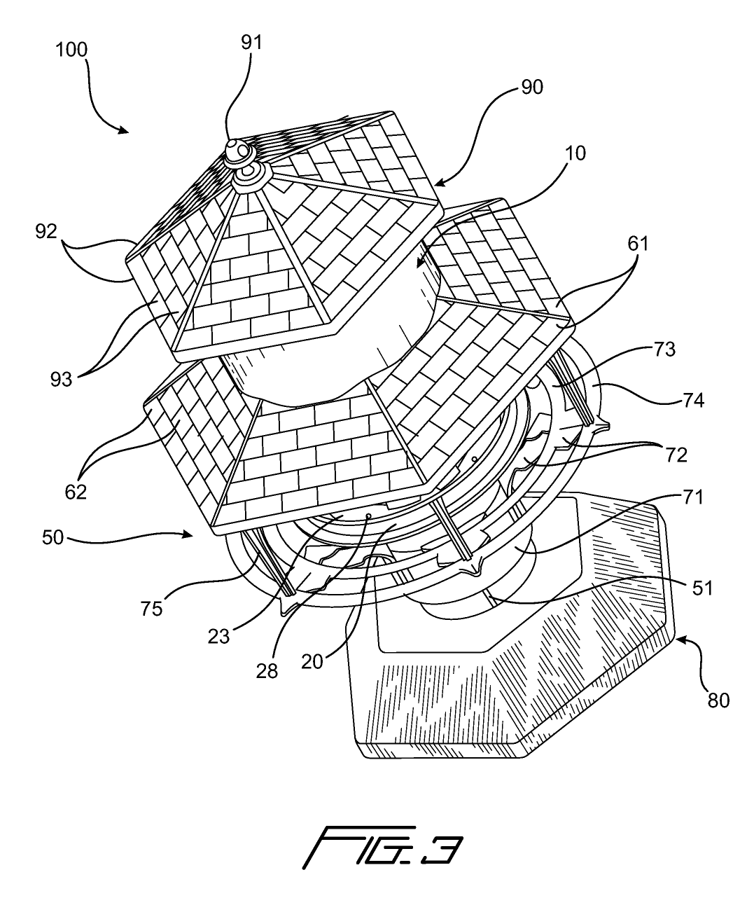

FIGS. 1-7 show various views of a presently preferred embodiment of the invention. As shown, bird feeder 100 consists of a central core member 10 having a large top cylinder 11 contiguous with a smaller bottom cylinder 12. The central core 10 is designed as a hollow tubular structure akin to common tube-type feeders configured to hold a supply of feed in its interior. Having, as discerned from the drawings, the present invention includes a larger top cylindrical portion 11, which as will be appreciated, allows for a greater volume of feed to be held in the central core thereby requiring less frequent refilling of the feed reservoir compared to other straight tube-type feeders. With reference to the drawings, the aesthetics of this embodiment of the feeder 100 readily lends itself to a two-tiered central core member 10, wherein each tier has a different diameter. However, the exact configuration of the central core member 10 is not critical to the invention and other geometrical configurations may be adapted for use with the present invention and achieve various of the desired objects and advantages of the invention. Modifying the design and/or shape of the feed cylinder for use with the present invention is well within the ability of one of ordinary skill in the art armed with the present specification and all such designs should be deemed within the scope of the invention.

The sidewall 15 defining the lower cylinder 12 also defines one or more feed openings 13. The feed openings 13 may be deployed in any suitable location and sized to provide a desired volume of feed. As will be appreciated, the feed openings 13 are typically provided at the bottom of the side wall 15 adjacent the bottom 16 of the feed cylinder 10 to allow the openings to be gravity fed and allow the entire reservoir of feed to be consumed before refilling.

Disposed around the side wall 15 is a feed trough 20. The feed trough 20 depicted in this embodiment comprises a collar operatively disposed around the feed cylinder sidewall 15 just below the feed openings 13. As will be appreciated, this disposition of the feed trough 20 allows for seed escaping the feed openings 13 to be captured and held in the trough's interior 22 in a manner accessible by birds visiting the feeder 10. While the feed trough 20 may be provided in alternate configurations, a collar arrangement is presently preferred for various reasons. For instance, a collar lends itself to ease of construction and assembly and disassembly. As best shown in FIG. 4, the feed trough 20 comprises two or more accurate sections 21 that include interior flanges 22 sized to snap into frictional engagement with the sides of the feed openings 13. When the sections are all snapped into place, a continuous seed moat around the circumference of the feeder 10 is formed.

As also best shown in FIG. 4, the feed trough 20 is configured to define a relatively deep moat for receiving seeds. The depth of the moat is such that it is shallow enough to allow birds to access seeds in the trough while being deep enough to prevent seeds from being shaken out of the trough by squirrels. The trough may also include an interior feed flow flange (not shown) sized to eclipse the feed holes in a manner that the size of the feed openings, and thus the flow of seeds, may be controlled. In one embodiment, the feed flow flanges are disposed such that the rotation of the feed trough 20 around the lower core 12 allows for the feed openings 13 to be anywhere from fully open to fully closed to the ambient environment. As will be explained in greater detail below, the configuration of the feeder and the disposition of the feed openings, trough, and/or feed flow flange greatly, and quite unexpectedly, conserve the amount of lost feed. As will be appreciated, feed often falls from prior art bird feeders due to wind, shaking of the feeder by animals, or other phenomena. The present invention, by contrast, has been shown to be at least six times more efficient in preventing seed waste. The present invention, and its cooperative components, has proven to be virtually squirrel proof and at a minimum, enormously reduces the loss of feed thereby making the feeder for more economical for the home owner to maintain.

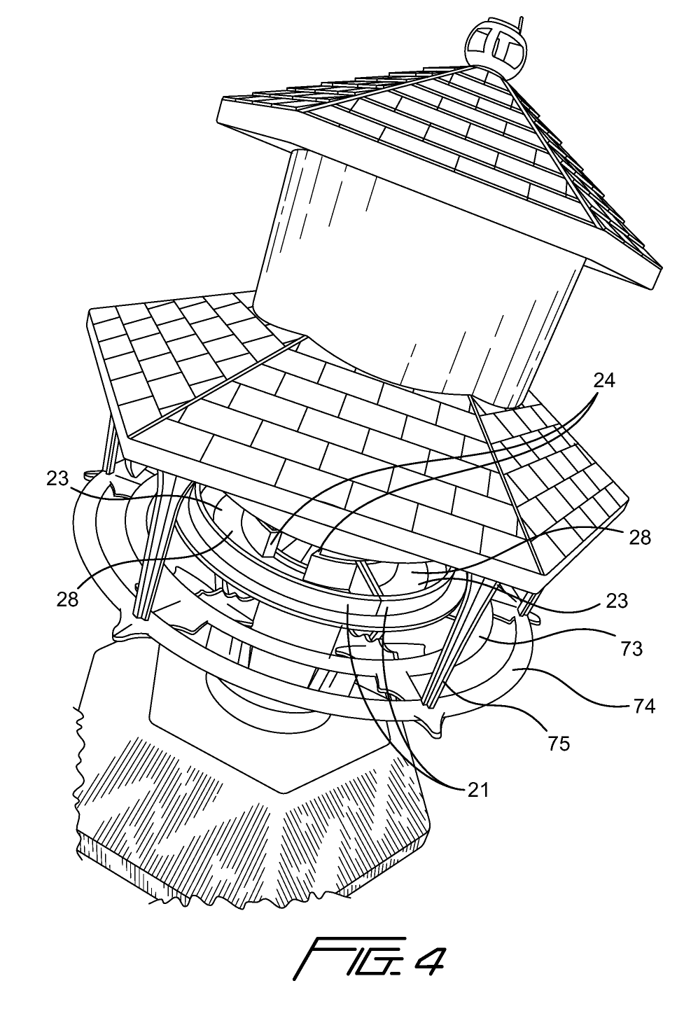

As best shown in FIG. 5, the floor 23 of the feed trough 20 also includes weep holes 28. The floor 23 of the trough 20 is preferably configured to gutter any rainwater that enters the trough 20 towards the weep holes 28 for drainage out of the feed area. The provision of a gutter system serves to keep the seed dry and safe by hindering mold and bacterial growth and also preventing clogging of the feed openings as is common with many prior art bird feeders. This in conjunction with the added protection from rain greatly enhances the usability of the feeder and lessens the frequency of cleaning and maintenance.

A particularly advantageous feature of this embodiment of the invention is, for the lack of a better term, the anti-squirrel “carousel” 50 arrangement shown in the figures. The term “carousel” was arbitrarily chosen in view of the physical resemblance of the anti-squirrel arrangement in the embodiment depicted and is not intended to be a term that describes the working features of the device. Any physical configuration that performs the analogous function of the anti-squirrel arrangement described herein should be understood to be within the scope of the present invention.

Returning to the figures, the anti-squirrel carousel 50 includes a carousel roof 60 connected to a bottom perch collar 70 via a plurality of vertical struts 75. The roof 60 is preferably sized to prevent a squirrel descending from the top from being able to reach the feed trough 20 and/or openings 13 without having to contact the roof 60. For aesthetics, the roof 60 may be constructed to mimic the roof of a home or other structure. In the embodiment depicted, the roof 60 includes a plurality of flat roof sections 61 slanted downwardly away from the feed cylinder 10. The roof sections 61 further include shingles 62 to add to the aesthetic effect. The shingles 62 in a preferred embodiment are copper that will age with time when exposed to the elements. In alternate embodiments, the shingles are constructed of synthetic materials to appear as aged copper. In other embodiments, the roof 60 comprises a symbol-shaped saucer that radiates equidistantly away from the feed cylinder 10. Any alternate configuration for aesthetics or otherwise that is constructed in a manner and sized to block the reach of a squirrel should be understood to be within the scope of the invention and is a matter of design choice for the intended end-user of the feeder 100.

The perch collar 70 includes a neck 71 having upwardly and outwardly extending arms 72 that terminate is plurality of horizontally disposed parallel perch halos 73, 74. The perch halos are sized and positioned to allow small birds to rest on the inner halo 73 and access feed and larger birds to rest on the outer halo 74 and access the feed. In this regard, the struts 75 cooperatively joining the roof 60 and perch collar 70 are similarly sized of a height that not only serves to block the reach of a squirrel but also sized to allow clearance for predetermined sizes of birds and not larger birds. As will be appreciated by one of ordinary skill in the art armed with the present specification, the halos and struts may be sized to serve a particular size of bird or may be made adjustable to allow bird feeders to be adjusted to serve different sized birds of the user's choice. Also, the arms 72 and struts 75 while serving utilitarian purposes may also be configured to add to the overall aesthetic look and feel of the feeder 100. For example, as shown in the figures, the arms 72 and/or struts 75 have an architectural cut to aid the overall gazebo or carousel look of the feeder.

The anti-squirrel mechanism of the present embodiment will now be described. As discerned from the figures, the carousel 50 has an annular opening that allows it to receive the feed tube 20 in its interior. The annular opening is sized to allow the carousel 50 to move up and down along the feed tube 20. In a presently preferred embodiment, the feed tube 20 includes raised bearings 51 disposed around the tube and extending linearly down a portion of the length of the tube 20. The bearings provide a smooth track(s) for the carousel 50 to slide up and down without binding. Reducing binding or other friction event helps prevent the feeder from being tilted to the side of a squirrel or other heavy intruder. By providing a mechanism that insures the carousel travels smoothly down to close the feed supply without tilting and spilling seeds, squirrels will not learn to jump on the feeder to quickly angle it to one side to allow feed to spill from the feed openings to the ground for them to collect and eat later. Moreover, bearings 51 or the like that help reduce friction or mechanical matting will likewise help hinder the feeder from getting stuck in the closed position. While the presently preferred embodiment deploys bearings lengthwise along the tube, ball bearings in a collar or other friction reducing technology may be used with the present invention. Also, the friction reducing components may be included as part of the carousel during manufacturing rather than the feed tube, or alternatively, be a separate part all together. For example, the carousel could be manufactured to include bearings, or alternatively, an annular ball bearing ring could be inserted around the top and/or bottom collars of the feed tube.

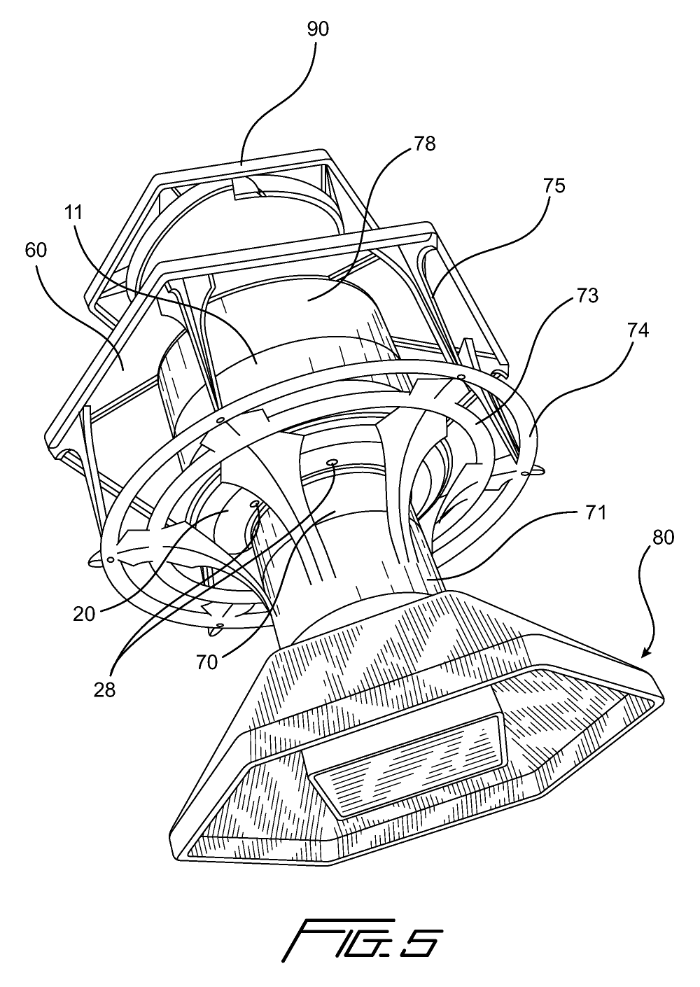

Turning back to the figures, the neck 71 of the perch collar 70 includes an internal spring 77, shown in FIG. 6, which is biased to hold the carousel 50 up off the feeder base 80 in suspension relative the feed tube 20. The spring force is sufficient to hold the carousel in this “open” condition, wherein a feed shut off flange 78 descending from the roof is held above the feed openings 13. Preferably, the spring force is sufficient to hold the carousel in the open condition even when birds are perched on the halos 73, 74 and feeding. However, the spring 77 is preferably configured such that when a squirrel, large bird, or rodent puts a predetermined amount of weight on any part of the carousel 50, the spring bias force is overcome and the carousel 50 slides down to rest on the seat of the base 80. The descent of the carousel 50 results in the corresponding descent of the feed shut off flange 78, thereby blocking access to the feed openings 13. As will be appreciated, this movement of the carousel 50 denies access to the feed by any animal heavier than the force of the spring 77.

The exact configuration of the feed shut-off flange 78 is not critical to the invention. Preferably, the flange 78 is configured to either rest against the floor 23 of the feed trough 20, or more preferably, cover the feed trough 20 as well as the feed openings 13. In any event, when the squirrel or other animal becomes discouraged and disengages the carousel 50, the spring 77 re-bias to force lift the carousel 50 back to the open position so that birds may return and feast on the seeds.

Preferably, the feeder bottom 80 is configured to allow for the tension force of the spring 78 to be adjusted. Any suitable means for adjusting the force it takes to close the feeder 100 should be understood as within the scope of the invention. For example, the neck 71 may be configured to be tightened to increase the internal friction force required to slide the neck down to the base. Alternatively, the base 80 may include a worm screw mechanism that adjusts the weight at which the carousel 50 will close.

As will be appreciated, an adjustable spring force allows the feeder 100 to be set for a certain weight of birds to rest on the perches. In this regard, a bird enthusiast may set the feeder 100 to close when large birds attempt to feed. More preferably, the adjustment mechanism includes a gauge or the like having predetermined settings and a scale so lay persons do not have to use trial and error to find a tension position suitable for a particular weight of bird. Additionally, the carousel 50 may include bearings that hinder binding when one side of the feeder 100 experiences all of the weight of a squirrel or other rodent.

As with most bird feeders it is desirous to suspend the feeder 100 off of the ground where only birds can reach it. For this purpose, as best shown in FIG. 7, the feeder bottom 80 includes a mounting opening 85 that may receive a pole. After fitting onto the pole, the pole is anchored into the ground leaving the feeder atop the pole at a desired height. In addition, the feeder 100 includes a top 90. The top 90 preferably includes internal threads (not shown) that cooperate with threads on the opening of the feed cylinder 20. Thus, the top 90 may be unscrewed to fill the feed reservoir and screwed closed to protect the contents from the elements. The top 90 also preferably includes a hanger 91 that is configured to allow the feeder to be suspended from a tree branch or the like. In some embodiments, the top may also include a thermometer adding to the utility of the bird feeder to a user.

As previously discussed, in the embodiment depicted, top mounting of the feeder greatly reduces exposure of the seed to rain. The center of gravity of the feeder in combination with the shape of the roof provides shelter from driving rains and winds. This is a particularly advantageous feature to those who may deploy the feeder in geographic areas that have regular, violent rain storms. Again, keeping the seed free from moisture helps keep the seed clean and safe, prevents clogging of the feed openings, and reduces the frequency of cleaning and maintenance.

Returning to the aesthetics, in the embodiment depicted, the top 90 is shaped to compliment the overall look of the feeder 100. For example, as shown in the figures, the top 90 includes one or more flat roof segments 92 that are sloped away from the center and also includes shingles 93 that match those of the carousel roof 60. When assembled, the complimenting roofs give the feeder a two-story building look. If desired, the color of the body, base, shingles, etc. could be painted to match the appearance of the user's own home. In this manner, the bird feeder may be sold or marketed as a kit. Moreover, given the presently preferred polycarbonate construction of many of the components, pigment(s) may be added to color the individual parts in the same, complimentary, or other color schemes during the manufacturing process.

Preferably, the various components of the feeder 100 are adapted to be disassembled for cleaning. For example, the bottom 80 and top 90 may be unscrewed from the cylinder 10 and carousel 50 slid off and the feed trough segments unsnapped from the cylinder. The respective parts may then bee cleaned and reassembled.

The component parts of the feeder 100 are preferably dishwasher safe to enhance the likelihood the unit will be cleaned. At a minimum, it is preferred that the feed tube 20 and feed trough 30 comprise a dishwasher safe material, since these surfaces contact the seed. A presently preferred material of construction is polycarbonate or a polycarbonate mixture. In addition to being dishwasher safe, polycarbonate and like materials are resistant to ultraviolet and infrared radiation, which offers further protection of the feeder as a reliable and safe food source.

Those skilled in the art will appreciate that various adaptations and modifications of the above-described preferred embodiments can be configured without departing from the scope and spirit of the invention. Therefore, it is to be understood that, within the scope of the appended claims, the invention may be practiced other than as specifically described herein.

We claim:

1. A bird feeder comprising:
a feed tube having a top a bottom and a sidewall defining a plurality of feed openings;
a carousel slidably mounted on said feed tube;
a spring biased to hold said carousel in a first position and when said bias is overcome allows said carousel to slide into a second position; and
a feed shut off flange integral with said carousel, whereby when said carousel is in a first position said feed openings are open and when said carousel is in a second position said flange blocks said feed openings.

2. The bird feeder of claim 1, wherein said carousel comprises a roof and neck operatively connected by a plurality of struts, said neck having a plurality of perches extending upwards therefrom.

3. The bird feeder of claim 2, further comprising a feed trough cooperatively disposed adjacent said feed openings.

4. The bird feeder of claim 3, wherein said trough includes a floor defining a plurality of weep holes.

5. The bird feeder of claim 4, wherein said floor is guttered towards said weep holes.

6. The bird feeder of claim 1, further comprising a feeder bottom, wherein said spring is disposed in said feeder bottom and adjustable to increase or decrease the weight necessary to move said carousel from said first position to said second position.

7. The bird feeder of claim 6, wherein said feeder bottom has an underside mateable with a pole for suspending said feeder atop thereof.

8. The bird feeder of claim 1, further comprising a top, said top selectively removable to provide access to an interior area of said feed tube.

9. The bird feeder of claim 8, wherein said top includes a hanger for suspending said feeder therefrom.

10. The bird feeder of claim 9, wherein said top includes a thermometer.

11. The bird feeder of claim 1, wherein said feed tube comprises a dishwasher safe material.

12. The bird feeder of claim 11, wherein said material is polycarbonate.

13. A bird feeder comprising:
a feed tube having a top end, a bottom end, and a sidewall defining a plurality of feed openings;
a removable feeder top disposed on said top end of said feed tube, said feeder top adapted to seal an internal reservoir of seeds disposed in said feed tube;
a feeder bottom disposed on said bottom end of said feed tube;
a moveable carousel disposed on said tube between said feeder top and said feeder bottom, said carousel including a feed shut off flange; and
a spring biased to hold said carousel in a position wherein said flange is above said feed openings, whereby a weight applied to said carousel sufficient to compress said spring results in said feed shut off flange descending to block said feed openings.

14. The bird feeder of claim 13, further comprising a feed trough disposed around said feed tube adjacent said feed openings, whereby said shut off flange is configured to block access to said trough.

15. The bird feeder of claim of claim 13, wherein said carousel includes a roof and said carousel roof and said feeder top include matching shingles.

16. The bird feeder of claim 13, wherein said feed tube comprises two cylindrical sections, said sections being a larger volume top section and a smaller volume bottom section.

17. The bird feeder of claim 13, wherein said feeder top, said feeder bottom, and said carousel are removable from said feed tube.

18. The bird feeder of claim 13, wherein said spring is adjustable to vary how much weight is required to close the feeder.

19. The feeder of claim 14, wherein said feeder includes a gauge having preset weights at which the feeder will close.

20. The feeder of claim 13, wherein said carousel includes bearings to prevent binding of said carousel when weight is unevenly applied to said carousel.
